(19) United States
(12) Patent Application Publication
(10) Pub. No.: US 2012/0324008 A1
(43) Pub. Date: Dec. 20, 2012

(54) SYSTEM AND METHOD OF TRACKING USER INTERACTION WITH CONTENT

(75) Inventors: Thomas B. Werz, III, Los Angeles, CA (US); James A. Beaupre, Los Angeles, CA (US); Eric J. Kim, Tujunga, CA (US)

(73) Assignee: MYSPACE LLC, Beverly Hills, CA (US)

(21) Appl. No.: 13/528,679

(22) Filed: Jun. 20, 2012

Related U.S. Application Data
(60) Provisional application No. 61/498,674, filed on Jun. 20, 2011.

(51) Int. Cl. G06F 15/16

(52) U.S. Cl. 709/204

(57) ABSTRACT

A method, apparatus, system, and computer program product provides the ability to track user interaction with content. An interaction with content by a user is recognized. Data related to the interaction is communicated, in a first engagement message, to a publishing service application. The data includes an identity of the user, an identity of the content interacted with, an engagement type, and an identity of the previous user who directly influenced the interaction. The publishing service determines a likelihood that the interaction will cause other users to further interact with the content. Upon a positive determination that the interaction will cause other users to further interact with the content, the determination is communicated to a viral influence application for further processing.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/498,674, filed on Jun. 20, 2011, by Thomas B. Werz III, James A. Beaupre, and Eric J. Kim, entitled “SYSTEM AND METHOD OF TRACKING USER INTERACTION WITH CONTENT,” attorneys' docket number 257.39-US-P1.

This application is related to the following co-pending and commonly-assigned patent application, which application is incorporated by reference herein:

U.S. patent application Ser. No. ______, filed on the same date herewith, by Thomas B. Werz III, James A. Beaupre, and Eric J. Kim, entitled “SYSTEM AND METHOD DETERMINING THE RELATIVE RANKING OF A NETWORK RESOURCE ON A NETWORK IN A DISTRIBUTED ENVIRONMENT”, attorneys' docket number 257.33-US-U1, which application claims the benefit of U.S. Provisional Application Ser. No. 61/498,666, filed on Jun. 20, 2011, by Thomas B. Werz III, James A. Beaupre, and Eric J. Kim, entitled “SYSTEM AND METHOD DETERMINING THE RELATIVE RANKING OF A NETWORK RESOURCE ON A NETWORK IN A DISTRIBUTED ENVIRONMENT,” attorneys' docket number 257.33-US-P1.

### BACKGROUND OF THE INVENTION

1. Field of the Invention

The present invention relates generally to social media, and in particular, to a method, apparatus, and article of manufacture for tracking user interaction with content and determining the viral influence of a user and content.

2. Description of the Related Art

In social media networks, there is often a desire to compare users (e.g., to each other) and resources to determine a level of activity associated with such users and resources. More specifically, there is a desire to track user interaction with content, particularly to determine an influence of a user within a network relating to one or more pieces of content (or to determine the “virality” of a piece of content). The prior art lacks an easy and efficient process for computing such a user influence.

Viral influence on a network, particularly a social network, begins with a piece of content that passes from one user to another. This may typically happen when one person likes, shares, follows, plays, comments on, or in some other way interacts with a piece of content. When this interaction is presented to another user, e.g., a user's friend, such other user may be more likely to interact with a piece of content. In such a way, a piece of content may be said to have become viral.

Traditional methods of determining the overall influence of a person within a network, e.g. a social network, and/or determining the virality of a piece of content requires computationally expensive solutions. Typically, offline data warehouses process massive amounts of information on a regular basis in an attempt to determine the influence and virality. This is an expensive process that can take days to run, resulting in data that is often out of date, and hence not useful. Such results are typically presented in back end reports with the results being utilized on an ad hoc basis.

Also, even with days of offline processing, it can be difficult to track the viral influence of a person or virality of a piece of content beyond several layers of depth.

Accordingly, there is a need in the art for improved mechanisms for tracking the viral influence of a user or determining the virality of a piece of content.

### SUMMARY OF THE INVENTION

One or more embodiments of the invention relate to a system and method for tracking user interaction with content, including communicating to a publishing service application (upon user interaction with content), an identity of a user, an identity of content interacted with, an engagement type and the identity of the previous user who directly influenced the content interaction. In exemplary embodiments, such publishing service may then determine whether the interaction could potentially cause other users to further interact with the content and, if so, communicate this to a viral influence application.

Exemplary embodiments include tracking user interaction with content or other users, particularly to determine an influence of a network resource within a network. Exemplary data related to such influence includes data indicating how a user influences one or more pieces of content (e.g., the “virality” of a piece of content), how users interact with a network site, or how users interact with other users. Some or all of such data may then be processed into a distributed statistical ranking to show real time rankings for viral influence, or a similar category.

Embodiments of the invention may also generate data by measuring the activities of a user/content relative to a network resource on a network site, and processing such data as a distributed statistical ranking to provide real time rankings for the resource. In exemplary embodiments, a user's engagement score is utilized to create a percentile ranking against all or a subset of user's scores on a network using statistical models applied across the network in predefined intervals.

Exemplary embodiments may also generate data by calculating the virality of content on a network site. In such exemplary embodiments, an exemplary viral influence application may keep track of the history of how a piece of content was interacted with, e.g. by tracking user identity, content identity and previous users that interacted with content, or generate a list of users that previously interacted with content utilizing information including user identity, content identity, previous user information and an indication as to how far away a current interaction is relative to such previous users' interactions (e.g., by indicating the number of levels away).

In other exemplary embodiments related to viral influence data, the publishing service application may then use such a list of previous users to generate new information relative to each of such previous users indicating a current user's interaction with the content, identifying the previous user, indicating how far away the current interaction is relative to the previous user and indicating that the previous user did not directly perform the current interaction.

In other exemplary embodiments related to viral influence data, an exemplary engagement aggregator service application may then take each of the newly generated information from the publishing service application and aggregate such information at different levels of granularity, e.g. at a first level of content identity and engagement type and at a second level of user identity, content identity and engagement type. The exemplary engagement aggregator service application may also store such aggregations for a predetermined period of time before sending them to a storage service. Shorter time periods may allow for more real time results, but also require more processing resources.

In other exemplary embodiments related to viral influence data, an exemplary storage service application may store engagements (interactions) at various levels of granularity, e.g., at a first level of user identity, content identity, engagement type and number of levels away or at a second level of content identity, engagement type or number of levels away.

In other exemplary embodiments related to viral influence data, the exemplary storage service application may track the date and time that each engagement was saved to the storage device. In such a way, an exemplary embodiment may also provide a mechanism to aggregate engagements by time once they reach a predetermined age.

Other exemplary types of data that may be collected include how users interact with a network site, or how users interact with other users on the network site.

Some or all of the data obtained from the above or similar process may then be processed into a distributed statistical ranking to show real time rankings for viral influence or other appropriate category.

As will be described in more detail below, exemplary embodiments utilize statistical models, such as Standard Score, or Z-Score, Standard Deviation and/or Percentile Ranking models, to provide user percentile rankings against the rest of or a portion of a network site.

### BRIEF DESCRIPTION OF THE DRAWINGS

Referring now to the drawings in which like reference numbers represent corresponding parts throughout:

FIG. 1 illustrates a plot of user scores for any given engagement value against the normal distribution of the population;

FIG. 2 illustrates the logical flow for determining the relative ranking of a network resource on a network in a distributed environment in accordance with one or more embodiments of the invention;

FIG. 3 illustrates a general exemplary system schematic that shows how user interaction with content may provide data to a viral influence service (or application) in accordance with one or more embodiments of the invention;

FIG. 4 illustrates an exemplary flowchart tracking overall shares of a song between users, as well as an indication as to how far away a current interaction is from previous user interactions;

FIG. 5 illustrates the logical flow for tracking user interaction with content in accordance with one or more embodiments of the invention;

FIG. 6 is an exemplary hardware and software environment used to implement one or more embodiments of the invention; and

FIG. 7 schematically illustrates a typical distributed computer system using a network to connect client computers to server computers in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the present invention relate to determining the overall influence of a person within a social network and determining the virality of a piece of content on a social network. Embodiments of the invention can be used to identify, in real time, which users are the biggest influencers on the site (e.g., finding patient zero). Such information can then be utilized for additional features such as reputation, targeted advertising, mailings, badges, prizes and giveaways, etc. Additional, the cost of finding this data via other means (e.g., expensive data warehouse calculations) is reduced. The time required to discover the information is also decreased by making it available in real time. Further, embodiments of the invention provide the ability to show users how their actions influence others. By presenting such information to users, such users will be incentivized in creating and spreading engaging content, which in turn will increase the engagement of users to a social network as a whole.

Described below is the ability to perform distributed statistical ranking of content/user/resource interaction followed by a description of viral influence.

### Distributed Statistical Rankings

After collecting real-time data about how users interact with each other and with content, the data can be input into a distributed statistical ranking to show real-time rankings for the data (e.g., with respect to viral influence or another appropriate category).

Embodiments of the invention utilize statistical models, such as Standard Score, or Z-Score, Standard Deviation and/or Percentile Ranking models, to provide user percentile rankings against the rest of, or a portion of, a network site.

Engagement Score

As used herein, a user's engagement score identifies a user's level of engagement/interaction with another user/website/resource etc. An engagement score may be categorized by the type of engagement. Further, the level of engagement/interaction may be determined using a variety of mechanisms/methodologies. To enable the engagement score to have some meaning, various different methods may be used to place the engagement score into the appropriate context.

Scoring Engagement Types Against Population

To add context/meaning to a user's engagement score, a user may be provided with a percentile ranking against some or all of a network (e.g., social media) site. To provide such a context/comparison with respect to a network site, statistical models may be used, e.g., Standard Score/Z-Score, Standard Deviation, and Percentile Ranking.

In one or more embodiments, the standard deviation and mean are calculated across a network site at regular intervals. This interval may be any desired interval and/or defined time period, e.g., on the order of minutes, hourly, across multiple hours, etc. The degree of near real-time performance may be balanced against performance as desired.

The calculation of the Standard Deviation and Mean will create the Normal Distribution, which a user's engagement value/score can be plotted against. As the user's value/score increases, so will the user's position on the curve.

A level of inaccuracy may be introduced as the interval between the calculations of the standard deviation and mean increases. Such an inaccuracy results because other user's values are changing independently from the curve. Once the curve is re-calculated, the users' positions may be adjusted. Nonetheless, the inaccuracies between calculation cycles may be corrected using historical data (e.g., by using the historical data to determine or estimate projected user's engagement values/scores).

In addition to the above, the plot may also be utilized to illustrate a user's score with respect to a specific population/group of users. However, such a plot may be more complex and expensive to perform, thereby potentially reducing the frequency at which the value can be calculated and plotted.

Any resource type can be ranked against its peers, e.g., users, songs, videos, etc. A change in score may also be ranked over a period of time (delta over time). This measures the acceleration of a resource, for example, “The Top 20 Songs” will be a list of the most popular songs on a social media network (e.g., Myspace™), and might not change over the course of a week. However, the song that has changed the most over the last week will be the list of the up-and-coming songs, e.g., the songs that are currently trending, but don't have the overall top plays. These windows/periods of time can be varied: hourly, daily, weekly, etc.

Normal Distribution

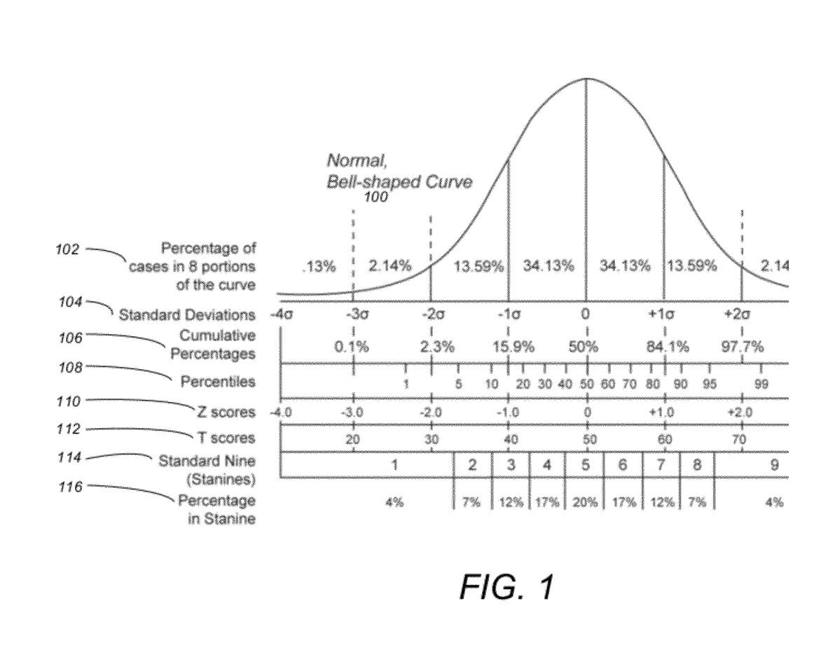

FIG. 1 illustrates a plot of user scores for any given engagement value against the normal distribution of the population. There is a normal distribution of the population is represented by the bell-shaped curve 100. The top most row 102 represents the percentage of cases/users in eight portions of the curve—13%, 2.14%, 13.59%, 34.13%, 34.13%, 13.59%, 2.14%, (the last portion is not shown). The second row 104 illustrates the standard deviations of the engagement scores from −4σ to +2σ. The third row 106 illustrates the cumulative percentages of the engagement scores. The fourth row 108 represents the percentiles of engagement scores. Based on the curves, a z-score 110 can be computed. The z-score 110 can be converted to a percentile, or, as illustrated in FIG. 1, any other value desired.

The mean of the population and standard deviation 104 define the curve 100. A simple formula can be applied to the user's value in real-time to get the user's position on the curve 100. The curve 100 may also be updated by re-calculating the standard deviation 104 and mean on a regular interval.

Calculating Mean

The mean (i.e., average engagement score) of the population can be calculated in parallel on each profile database at the same time. This allows the system to scale the process, giving linear performance. Better performance means the ability to recalculate more frequently. The following equation can be used to calculate the mean x̅ (for an engagement score x with a population n)

$$\overline{x} = {\sum }_{j = 1}^{n} {x}_{j} / n$$

The mean may then be adjusted against the % of population on each database. For example: Myspace187 has 800,000 users who are part of the calculation. The entire site has 100,000,000 users across all profiles involved in the calculation. The mean for Myspace187 would be multiplied by 0.008 (800000/100000000). This weighted average would be summed for each profile range to create the average mean for the site.

Calculating the Standard Deviation

The standard deviations 104 can be calculated in parallel by using the raw score method based on the following equation:

$${σ}^{2} = \frac{\sum {X}^{2} - \frac{{( \sum X )}^{2}}{N}}{N}$$

where σ is the standard deviation, S is the engagement score, and N is the total population.

In exemplary embodiments, the components of this calculation may be summed on each profile range. The summed values may be centralized to produce a global standard deviation to normally distribute user activity.

Using the Standard Deviation and Mean to Produce a User's Rank

In exemplary embodiments, generating the location of a value along the curve as defined by the standard deviation and mean may be performed using a standard score method. The standard score (also known as Z-Score 110) provides the position of a value along the curve. This Z-Score 110 can then be used to generate a user-facing ranking, or simply converted to a percentile.

$$z = \frac{x - u}{σ}$$

where x is the engagement score, μ is the mean, and σ is the standard deviation.

### Exemplary Implementations of Distributed Statistical Ranking

The distributed statistical ranking described above can be utilized in/for a variety of different implementations. The descriptions below provide examples of some of these implementations.

User Relevance

The system may use action points or discovery points to calculate a user's percentile ranking relative to the other users on the site. The relative percentile ranking may be calculated over various time periods, such as one (1) day, seven (7) day, one (1) month, and all time. Further, the relative percentile ranking can may be tracked over time to determine whether a users ranking relative to other users has increased or decreased. If desired, a users ranking may also be shown among their friends, as well as showing how this has changed over time.

Dashboard

The relative ranking for a user or any piece of content that they own can be displayed in a dashboard. Users may also be given an “at a glance” view of how they are doing relative to everyone else on a social network using charts and graphs, spider web charts, etc. (e.g., within a dashboard). As used herein, a dashboard refers to a toolbar, tool, application, and/or window that can be used to provide information or to select services/applications.

Levels for Reputation

One Way to assign levels to a user is to just use their distributed rank. For instance, if a user is in the 58^{th} percentile, the user may be assigned to level 58. This will mean that a user's level will go down if the user stops interacting with the site, if people stop interacting with the user, etc.

Top User Influence

Top users may be permitted to influence the direction of a product/application (e.g., Myspace™). In this regard, once the distributed statistical ranking is obtained, top users on a social network, based on their relevance ranking (e.g., from the distributed statistical ranking or from another website/application that provides the ranking—e.g., the Wildfire™ application), may be allowed to have a direct line of communication with social network development teams. Users' suggestions may be used, e.g., to create a product backlog, which can be broken up vertically or handled all by one team. Thereafter, social networks may actually implement what users are asking for. A process may also be provided by which users can see that their suggestions are being heard (when an administrator reads them, responses from the administrator, etc.) so that users feel like their feedback is being used and that they are being heard.

Automated Suggestions

By analyzing (data mining) engagement trends over a large number of users, the system may determine which types of engagements are going to be the most valuable to a user for increasing a user's EPV value, social/discovery points, or action points. Accordingly, automated suggestions will help users who are low in ranking determine what to do next, similar to what credit bureaus suggest people to do in order to increase credit scores.

Custom Support Priority Queue

Users who are ranked higher can be automatically prioritized in a support queue.

User Competitions

The system may also use user relevance scores to give prizes (could be a virtual badge for bragging rights or something physical) to the top users. Top users can be calculated over any time window.

Gifting Points

Points may be gifted to boost a user's relevance ranking. In exemplary embodiments, users with a large number of social points are allowed to “boost” other content by assigning extra points to it. The higher a user is ranked (social points) the more points the user may be allowed to give to other content on the site. Points may be provided via a channel (e.g., area of a website) for taste makers to temporarily increase the relevance and ranking of a band, a video, a song, a profile, or any other content on the site. Users can have a set number of points they can gift every 24 hours (rolling) that will recharge over time. In exemplary embodiments, points do not increase beyond the daily maximum for the user.

### Distributed Statistical Ranking Logical Flow

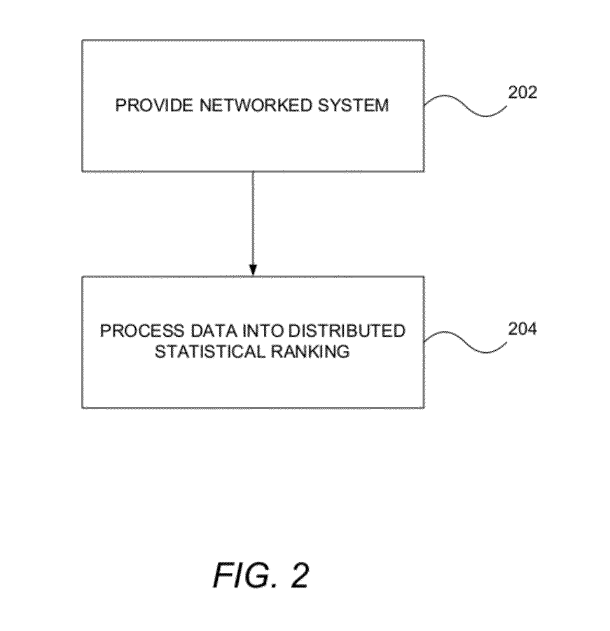

FIG. 2 illustrates the logical flow for determining the relative ranking of a network resource on a network in a distributed environment in accordance with one or more embodiments of the invention.

At step 202, a network system that is configured to recognize and collect data representative of activities regarding network resources on a network site is provided. Such network resources may include users, user content, songs, videos, or other content located on the network site. The data may represent how a user interacts with some or all of the network site, how a network resource is interacted with by a user, and/or may include viral influence data (as described in further detail below).

At step 204, the data is processed into a distributed statistical ranking to show real time resource rankings relative (e.g., determined at a regular defined intervals) to a predefined subset of the network site. Such a ranking may indicate a user's ranking relative to other users, to a user's friends, or to one or more users over a period of time. Further, the processing may be via standard/z-score, standard deviation, or percentile ranking models to calculate a network resource percentile ranking against at least a portion of the network site. In this regard, the resource ranking may be a measurement of the standard deviation and mean (where the standard deviation and/or mean may be calculated in parallel on plural profile databases at the same time) of a network resource engagement score across a portion of the network site. The mean value may also be adjusted against a percentage of population on each database while the standard deviation calculation may be used to produce a global standard deviation. The network resource percentile ranking may be calculated over a period of time (e.g., hourly, daily, weekly, or any other defined period of time [defined by the user or otherwise]) to show acceleration/deceleration of the resource.

As described herein, the resource ranking may also be used to assign a user level to a user. Such a level may then be used in further processing (e.g., to provide additional benefits to the user). In one or more embodiments, communications with network development, support or administrative personnel may be allowed or prioritized for a user with a particular real time resource ranking.

Steps 202 and 204 may include multiple components that perform various activities as described in further detail below. For example, at step 202, the networked system may also be configured to recognize an engagement of content by a user. Data related to the content may be communicated to a publishing service application. The data can include an identity of a user, an identity of content interacted with, an engagement type, and the identity of the previous user who directly influenced the content interaction. The publishing service (which is part of the networked system and performs the processing at step 204) determines a likelihood that the interaction will cause other users to further interact with the content. Upon a positive determination that interaction will cause further interaction, the positive determination (and other information) may be forwarded to a viral influence application.

The processing of the data 204 may also be used to present the data to a user (either a network user or an administrator that is using such data). For example, a network resource's engagement score may be plotted against a normal distribution derived from the standard deviation and mean such that when the engagement score increases, the resource's position on a plotted curve also increases. Historical data may also be used to correct inaccuracies in the plotted positions between calculation cycles. The data may be presented/displayed to a user/administrator in a user dashboard.

In response to a ranking and to encourage a user's interaction with a network site, recommendations may be provided to a user that would likely result in a boost to a user's relative ranking. To further encourage a user's interaction, prizes or awards may be provided to a user based on the user's relative ranking. In addition, an active user may be awarded virtual points that the active user can grant/award to other users and/or resources thereby increasing such a resource's (and/or user's) ranking (temporarily). Such points may be give to an active user on a periodic basis and/or points may partially recharge (e.g., from/to a maximum number of points) during of after such a period.

In view of the above, embodiments of the present invention provide simple, quick and efficient mechanisms for seeing how a user, photo, video, song, or any other resource on a network ranks relative to other content of the same type. Further embodiments allow this to be done in real or near-real time, so that as resources are interacted with (song plays, users profiles visits, video comments, etc.), the ranking of the resource will change. This accordingly alleviates the need to have to rely on expensive offline calculations in a data warehouse or expensive nightly aggregations of data. Also, by providing a flexible way to combine different counters in a formula, generating motile statistical rankings becomes a very inexpensive process.

Exemplary embodiments also advantageously boost performance by allowing processing data in parallel, which allows for the possibility of scaling indefinitely. In other exemplary embodiments, performance is also boosted by defining that each server will be responsible for its own calculation. Reducing the calculation from centralizing, e.g., 200 million records, then processing this giant dataset, exemplary embodiments have effectively distributed the calculation, whereby each node has to only deal with, e.g., ˜600K records. This will enable the system to perform the process more frequently.

Exemplary embodiments also advantageously boost accuracy by using a raw score method, which allows the system to perform all calculations needed in a single pass, whereas other methods require a global mean to be calculated first, then the variance of each record against that global mean. Exemplary embodiments also provide that the system doesn't have to perform sampling. Instead, the system can include the entire population in the calculation. Finally, exemplary embodiments provide that the system doesn't have to average each node's standard deviation, which would result in more inaccurate values.

### Viral Influence

The distributed statistical ranking described above provides the ability to visualize, measure, and/or depict a ranking of content on a social network in real time. The distributed statistical ranking places the engagement of the user (with content) into a context of the general population's engagement.

Closely related to distributed statistical ranking is the ability to track the virality of content on or outside of a social network in real time. Viral influence provide such a methodology. Viral influence provides users on a social network with a mechanism to observe how their actions of creating, sharing, and interacting with content affect how other users interact with the same content. The overall viral influence of a user is calculated in real time based on all of the content the user has interacted with. Virality also provides insight into how a particular piece of content has been interacted with, including who interacted with the content, who influenced interaction with the content, and when it happened. The virality of a piece of content is tracked for any number of users and up to any number of levels deep.

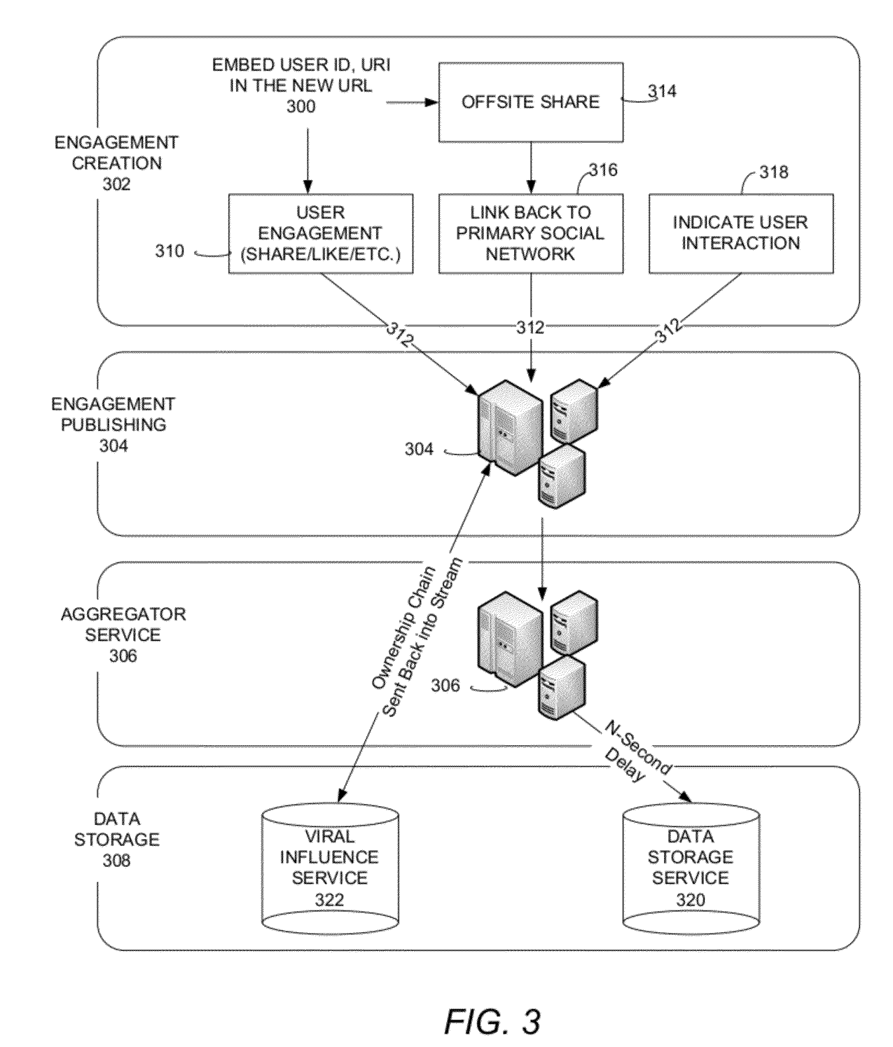

FIG. 3 illustrates a general exemplary system schematic that shows how user interaction with content may provide data to a viral influence service (or application) in accordance with one or more embodiments of the invention.

The first stage of the process is that of the creation of engagement 302 with content. Once created, the engagement is published at 304. The engagement content from multiple locations are then aggregated using aggregator service 306 and then stored in data storage at 308.

Viral influence beings with a piece of content that passes from one person to another. This typically happens when one person likes, hares, follows, plays, comments on, or in some way interacts with a piece of content. When this interaction is presented to the user's friends, they are more likely to interact with the content themselves and so on, which is one way for content to go “viral”.

Accordingly, an exemplary viral influence application may keep track of the history of how a piece of content was interacted with, e.g. by tracking the user identity, the content identity, and the previous users that interacted with the content. Alternatively, a viral influence application may generate a list of users that previously interacted with the content utilizing information including the user identity, the content identity, previous user information, and an indication as to how far away a current interaction is relative to such previous users' interactions (e.g., by indicating the number of levels away).

Referring again to FIG. 3, to track the virality of content, when the content is passed from one user to another, the user id for that user and/or the uniform resource identifier (URI) for the content may be embed into a URL at 300. User interaction with such content may be initiated via a share of the content with another user, an indication that a user likes that content or some other form of interaction. Such a user interaction is referred to as an “engagement” 310.

An engagement message 312 is then sent to a publishing service 314. Other similar engagement messages 312 may similarly be generated, e.g., where content is shared to a secondary site 314 (e.g., a different social network or social communication mechanism such as Facebook™, Twitter™, etc.) and then linked back to a primary social network site 316. Alternatively, an external site may be configured to communicate with a primary site to recognize/indicate such user interaction 318. For example, a message may be “retweeted” or “reshared” on a primary or secondary (e.g., external) social network.

Accordingly, when a user interacts with a piece of content, the engagement message 312 is sent describing the interaction to a publishing service 304. The engagement message may contain:

a. User: The user (e.g., a user ID) who interacted with the resource;

b. Resource: The resource (e.g., a resource ID or URI) which was interacted with (a song, a video, a user, etc);

c. Engagement Type: The type of interaction (e.g., video play, song like, etc); and

d. Previous User: The previous person (e.g., a user ID) who interacted with the content and was thus the cause of this user interacting with it.

The publishing service application 304 may then use such a list of previous users to generate new information relative to each of such previous users indicating a current user's interaction with the content, identifying the previous user, indicating how far away the current interaction is relative to the previous user and indicating that the previous user did not directly perform the current interaction.

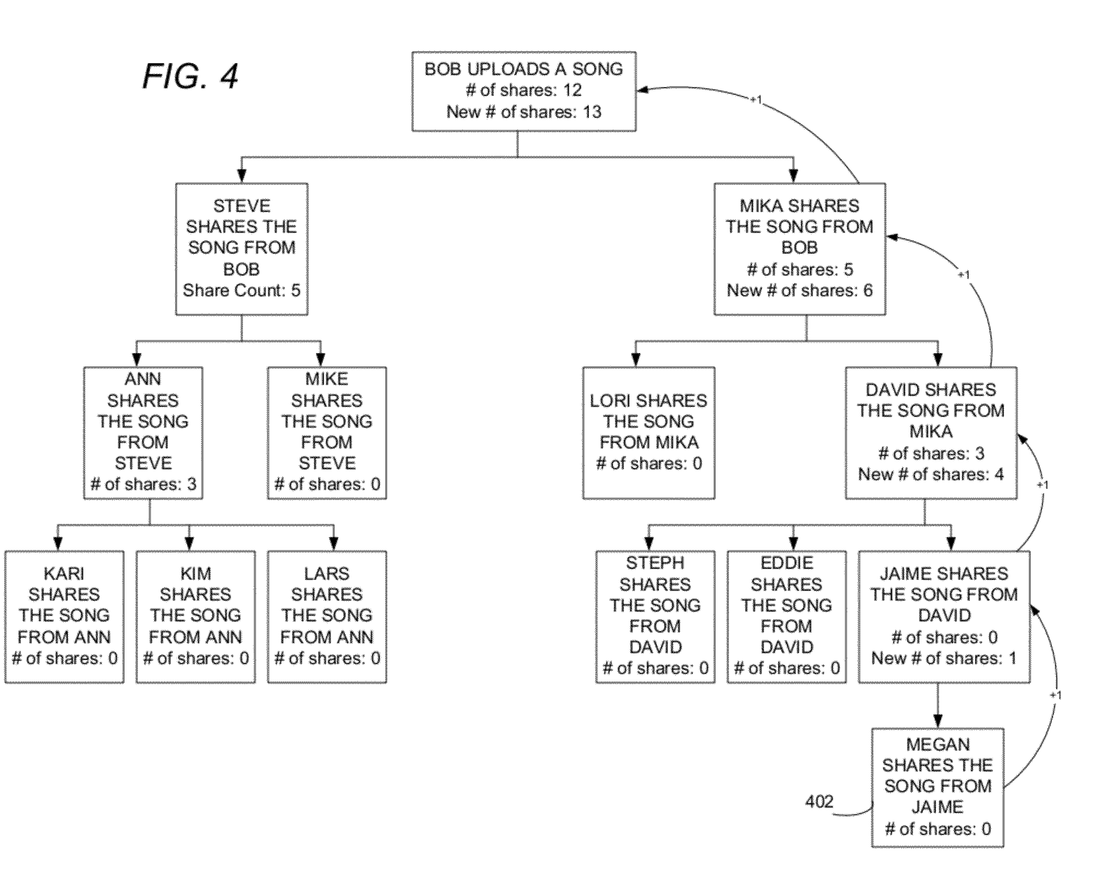

FIG. 4 illustrates an exemplary flowchart tracking overall shares of a song between users, as well as an indication as to how far away a current interaction (see box 402 in FIG. 4) is from previous user interactions. As illustrated in FIG. 4, Bob uploads a song and maintains an aggregated count regarding the number of shares and the number of new shares. Mika and Steve both shared the song from Bob (for a share count of 2). Ann and Mike then shared the song from Bob, with Kari, Kim, and Lars further sharing the song from Ann. Thus, on the left side of FIG. 4, a total of five (5) shares can be attributed to Bob (three for Kari, Kim, and Lars, one from Ann, and one from Mike) and all six (6) (including Steve) can be attributed to Bob. On the right side of FIG. 4, there is a total of seven (7) shares to provide Bob with a total of 13 shares (six via Steve, and seven via Mika). The “+1” arrows indicated additional levels of sharing that have occurred.

Returning to FIG. 3, the publishing service 304 has various options upon receipt of the engagement message 312. The publishing service 304 may inspect the message 312 to determine if the interaction could potentially cause other users to further interact with the content. If so, the message 312 is forwarded to the viral influence service 322. Alternatively, or in addition, the publishing service 304 may send the message to an engagement aggregator service 306 (this is merely exemplary but may be desired for scalability).

The engagement aggregator service application 306 may then take each of the newly generated information from the publishing service application 304 and aggregate such information at different levels of granularity, e.g. at a first level of content identity and engagement type and at a second level of user identity, content identity and engagement type. The exemplary engagement aggregator service application 306 may also store such aggregations for a predetermined period of time (i.e., an N-second delay) before sending them to a storage service 320. Shorter time periods may allow for more real time results, but also require more processing resources.

A storage service application 320 may store engagements (interactions) at various levels of granularity, e.g., at a first level of user identity, content identity, engagement type and number of levels away or at a second level of content identity, engagement type or number of levels away.

Additionally, the exemplary storage service application 320 may track the date and time that each engagement was saved to the storage device. In such a way, an exemplary embodiment may also provide a mechanism to aggregate engagements by time once they reach a predetermined age.

As described above, a viral influence service 322 may be configured to track the viral influence relative to ownership (engagement) chain data though a publishing service 304 and aggregator service 306 to determine the viral influence of content. Thus, the viral influence service 322 may provide one or more functions. As a first function, the viral influence service 322 may keep track of the history of how a piece of content was interacted with. Such a history may track at a minimum: the user, the resource, and the previous user.

In addition, the viral influence service 322 may returning a list of people who previously interacted with the resource to the publishing service. Such a list may contain the user, the resource, the previous user, and/or the number of levels away (i.e., how far away this interaction was from the current person).

When the publishing service 304 receives a list of previous users from the viral influence service 322, the publishing service 304 may create a new engagement message 312 and forward the new engagement message 312 to an engagement aggregator service 306. The new engagement message 312 is created for each previous user in the list of previous users and may contain:
i. The same user, resource, and engagement as the original message;
ii. The previous user: from the list of previous users, one per message;
iii. NumLevels: How far away this interaction was from the current person. The previous user will always be one level away, the user before that two levels, etc. and
iv. A viral engagement flag: This indicates that the user did not directly perform the action, but that the action was performed indirectly as a result of something they did.

An engagement aggregator service 306 may optionally be included/utilized to improve scalability. Such an aggregator service 306 may be configured to multicast messages, aggregate at different levels of granularity, and store aggregations for a defined period of time. For aggregating at different levels of granularity, the aggregator service 306 may be required to perform aggregations at the following levels:
i. Resource, Engagement Type; and/or
ii. User, Resource, and Engagement Type.

After storing the aggregations for a defined/set period of time, aggregator service 306 may send the aggregations to a storage service 320. The period of time may be seconds, minutes, and/or can be configured. Shorter time periods provide more real time results but require more resources to process.

The storage service 320 may store engagements at several levels of granularity (including: (a) User, Resource, EngagementType, NumLevels; and/or (b) Resource, EngagementType, NumLevels), may track the date/time that each engagement was saved to the storage service, and/or may optionally provide a mechanism to aggregate engagements by time once they reach a predetermined age. For example, at the end of each day, all engagements for the same user, engagement type, and numlevels can be aggregated together into one record. This may be done to reduce storage requirements.

Use of Virality Information

Using the viral influence components of FIG. 3, the virality of a resource may be determined. The virality of a resource may then be utilized in a variety of ways.

Influencing User

One use of the virality information is that of determining/finding which user has the biggest influence on a piece of content going viral (patient zero). In this regard, viral influence relates to users making resources/content popular. For any resource, an exemplary system can determine which users had the biggest influence on its usage. For example, if a video has one (1) million plays, a determination can be made regarding which users had the biggest impact on making that happen.

To determine which user has the biggest influence, the following two steps may be performed:

a. For any given user and engagement type, all of a user's engagements for the resource in question that have their viral engagements flag set to true are added together. These are the interactions that other users had with the resource because of the user in question. The sum of these interactions is the total influence the user had on the resource and can be considered their viral points. The viral points on the resource for each user can be compared to all other users that interacted with the resource to determine which users had the largest overall impact in spreading this resource to more users.

b. If there are multiple engagements with a single resource by a user, they can be combined in a formula to show a composite viral points score. For instance, if a user caused one hundred (100) plays of a video and five (5) shares of a video, exemplary embodiments may find it more beneficial to weigh the shares more heavily for purposes of calculating viral points. One formula that may be used is:

TotalPlays*1+TotalShares*50

indicating that a share is fifty (50) times more valuable than a play in terms of viral points.

Biggest Influencers

The virality may also be used to determine the biggest influencers on a social network/site. Once a user's viral points for each resource they have interacted with are known, the viral points can be added together to determine the user's overall viral points. The users with the largest, number of viral points are the ones who have the biggest impact to virality on the site because they cause more plays, shares, likes, comments, views, etc. than any other users. Exemplary embodiments recognize that for a variety of reasons, this is a valuable segment of users to identify. Further, such a determination can easily be done in real time. In this regard, by adding up the total number of viral points the user accrued over a window of time, one can determine: (1) the most influential users over the last hour, day, week, month, or any other time frame in real time; and/or (2) the most influential users for any time window in the past that data has been collected for.

Virality in a Reputation Game

A major component of a user's reputation is how others perceive them. One way to measure how one is perceived on a network (e.g., a social network like MySpace™) is to add up the viral points the user has accrued. More viral points mean a better reputation. This can be incorporated into a social game where users are awarded experience points for interacting with the site. Viral points can be the cornerstone of this game, since, in exemplary embodiments, creating or surfacing interesting content on the site and causing other people to interact with such content may be considered highly valuable. To achieve the highest levels in a reputation game, a user will need to have a high number of points. In exemplary embodiments, having a high number of viral points will be the easiest way for a user to achieve a desired reputation.

Advertising

By determining which users are influential on a network, the network host can charge a higher CPM (cost per impression) for advertising to such users because those users have been identified (in real or near real time) as having more influence over other people on the network. Exemplary embodiments of the present invention recognize that most advertisers would want these users to purchase their product because it will increase the respect of their brand via influential people. Also, the ability for measuring user's influence in real time may be integrated with advertising campaign parameters to create a more properly valued budget allocation plan.

In addition, a network host or advertiser can channel content that the host or advertiser wants to become viral through users with a high number of viral points by putting it in front of them.

Curators

A network host can make the people with the highest viral influence, official curators on the network. In exemplary embodiments, these users can be given a special discovery channel where users can find interesting content from these curators, friend/follow them, etc.

Dashboards and Spider Web Charts

A network host can display virality data about a user in a dashboard for them or for other users. One exemplary embodiment displays this data in a spider web chart, where a user's viral influence in various areas is depicted in different corners of the web. For instance, viral points related to photos, videos, and music can be tracked separately. A user can then see how influential they are in each individual area vs. other users on the site.

Badges

Users can be awarded badges for gaining viral points. For example, badges may be awarded for achieving one or more of the following milestones:

a. Being ranked in the 90th percentile among all users in virality;

b. Performing an activity that five (5) other users “like” directly from you;

c. Performing an activity that 25 users “like” any number of levels away from you (e.g., friend of friends who saw your update, etc.); and

d. Achieving a high rank (e.g., 90th percentile+) in virality for two consecutive months.

Accordingly, a variety of different badges may be awarded for achieving different virality ranks, achieving a virality rank over a defined period of time, for being a viral user (and/or causing content to become viral), etc. In this regard, any type of rules may be established for awarding badges as part of an effort to encourage users to interact with a site/resource and to find content/resources that other users will interact with.

Content Promoter

Because the viral influence of all users can be tracked (what songs were played because of them, what videos were shared because of them, etc.), content owners/promoters (e.g., bands) will be able to determine how much specific users are contributing to “spreading the word” about their content. This is similar to how club promoters work—when an individual shows up at the club, the promoter who is responsible for the individual's attendance, receives the credit for such attendance. The more people show up, the more the club appreciates the promoter, and the more money the promoter (and club) make. Thus, in exemplary embodiments, a network host can give bands, comedians, etc. the ability provide credit to the appropriate party/user/promoter on a social network by having users promote their songs, videos, etc. Such credit may further provide the ability to compensate such promoters (e.g., monetarily or non-monetarily).

User Influence of Social Network

Based on a user's virality score, top users may be permitted to influence a direction of a network product. For example, a network host can allow the top users on the network, based on their virality ranking, to have a direct line of communication with network development teams. The host can use their suggestions to create a product backlog, which can be broken up vertically or handled all by one team, and then actually implement what users are asking for. In exemplary embodiments, a host can build a process by which users can see that their suggestions are being heard (when a host reads them, responses are generated from the host, etc.) so that users feel like their feedback is being used and that they are being heard.

Taste Makers

Points may be gifted to boost relevance. In exemplary embodiments, users with a large number of viral points can “boost” other content by assigning extra points to it so that the content is ranked higher on network charts, in trending, etc. For example, the higher a user is ranked (social points) the more points such a user may be allowed to give to other content on the site. This can be a channel for tastemakers to temporarily increase the relevance and ranking of a band, a video, a song, a profile, or any other content on the site. Users can have a set number of points they can gift every twenty-four (24) hours (rolling) that will recharge over time. In exemplary embodiments, points may not increase beyond a daily maximum for the user.

Award Program

In one or more embodiments, users with a high number of viral points (or users ranking within a certain category of virality or who have achieved a certain milestone) may be awarded benefits. Such benefits may take a variety of forms, from monetary (e.g., cash back), to gift cards, to event tickets (e.g., premier concert ticket opportunities), etc. Such an award program may be similar to a mileage award program offered by airlines or credit card companies that exchange/award/reward customers/users for certain levels of activity. For example, users with a lot of viral points can get better opportunities may be granted the opportunity to buy or get discounts on tickets to see a band, be allowed to purchase premium seating that is hard to get, meet an artist in person (e.g., backstage passes), etc.

### Overview of Virality Influence

As has been described above, in exemplary embodiments, viral service information advantageously gives users and/or administrators on a network, e.g., a social network, a way to observe how their actions of creating, sharing and interacting with content affect how other users interact with the same content. In such a way, an overall viral influence of a user may be calculated in real time based upon all of the content they have interacted with. Embodiments of the invention also provide insight into how a particular piece of content has been interacted with, e.g., including who interacted with the content, who influenced interaction with the content, and when such interaction occurred. Virality of a piece of content can be tracked for any number of users and up to any number of levels deep.

Thus, aspects of the exemplary viral influence aspects of the present invention can advantageously be used to identify, in real time, which users are the biggest influencers on a site (e.g., finding patient zero). Such information can be used for additional site features, e.g., indicating a reputation of a user, for targeted advertising, for mailings or badges or prizes or giveaways, etc. Such embodiments advantageously overcome the traditional methods requiring expensive data warehouse applications and decreases the time required to obtain this data relative to those warehouse operations. Finally, in aspects where users can see how their actions influence others, users are incentivized in creating and spreading engaging content, which in turn increases the engagement of users to the primary site as a whole (e.g., an entire social network).

Additionally, exemplary embodiments may collect types of data other than viral influence data. In one such exemplary embodiment, data is collected representing how a user interacts with some or all of a network site. In another such exemplary embodiment, data is collected representing how a user, a user's content or network site resources are interacted with by other users.

### Viral Influence Logical Flow

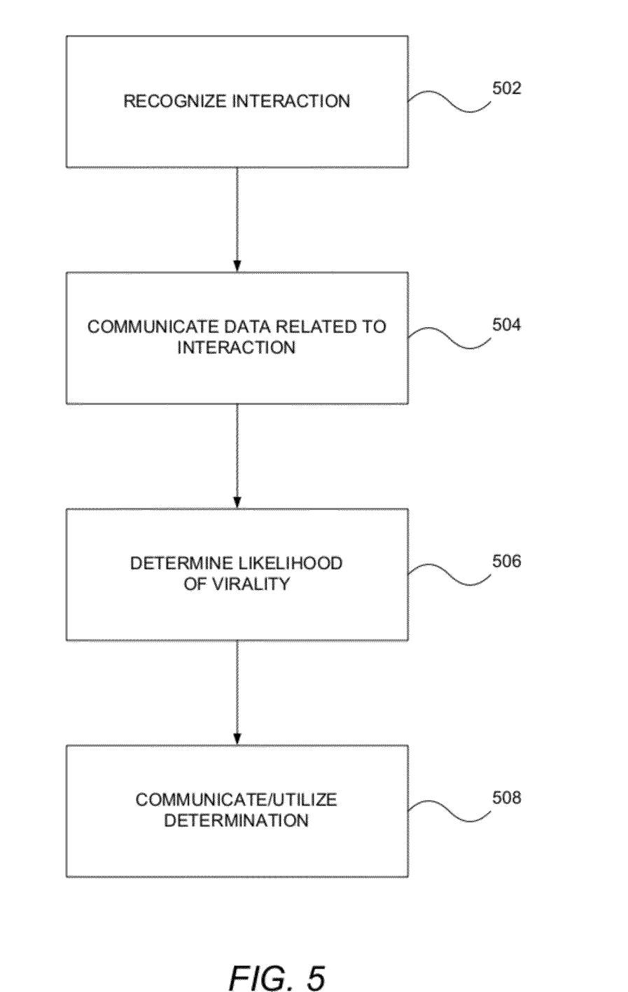

FIG. 5 illustrates the logical flow for tracking user interaction with content in accordance with one or more embodiments of the invention.

At step 502, the interaction with content by a user is recognized. Such interaction may include the sharing of content, the viewing of content, or an indication that the user “likes” the content. Alternatively, the interaction may consist of a user sharing the content to a secondary site (e.g., an audio/video hosting site) followed by linking the content back to a primary site (or by receiving a communication at the primary site that such sharing has occurred.

At step 504, data related to the interaction is communicated, in the from of an engagement message, to a publishing service application. The data in the engagement message includes an identity of the user, an identity of the content interacted with, an engagement type, and an identity of the previous user, if any, who directly influenced the interaction.

At step 506, the publishing service makes a determination regarding the likelihood that the interaction will cause other users to further interact with the content.

At step 508, upon a positive determination at step 506, the determination is communicated to a viral influence application that may perform further processing and/or may utilize the information (e.g., that determines whether users have influence on content relative to other users). For example, the viral influence application may track a history of the interaction with the content by tracking the user identity, the content identity, and the previous user identity. The viral influence application may further generate a list of the previous users that previously interacted with the content. Such a list may indicate how far away a current interaction is relative to interactions of the previous users. Such a list may be send back to the publishing service application to generate a new engagement message for each of the previous users. The new engagement message identifies the user and content (the same as the first engagement message) as well as the prior user's identity, an indication regarding how far away the current interaction is (relative to the previous user) and a viral engagement indication. Such a viral engagement indication indicates that the user (identified in the new engagement message) did not directly interact with the content but performed some action that indirectly caused the interaction.

The new engagement message may be used by an aggregator service application to aggregate the data in the messages. Such an aggregation may be performed at multiple levels of granularity (e.g., a first level with the content identity and engagement type, and a second level with the user identity, content identity, and engagement type). The aggregator service may further store the aggregated data (e.g., locally) for a predetermined/predefined period of time prior to forwarding the aggregated data to a storage service application.

Step 508 may further include a storage service application that aggregates the data once the data has been stored for a defined/predetermined period of time.

Further to the above, to determine whether users have influence on content relative to other users, the viral influence application may sum all interactions for the content (where the user directly performed the interaction). Such a sum represents a total influence that the user had on the content and may be compared to a corresponding sum of other users (to determine the relative influence). If a given user has interacted multiple times with the same content, each interaction may be weighted based on the engagement type (e.g., a content share, a content view, a content “like”, etc.).

In addition, a score may be assigned to a user with respect to all content that a user has interacted with on a site (e.g., a social network) and compared to other users to determine which user has the larger overall influence on that site. Based on such a score, a level or experience points may be awarded to the user (e.g., as part of a user's “reputation” or as part of a game). Alternatively, awards, recognition, communications access (or priority to a network host, affiliate, or content owner) may be granted to a user based on the user's influence relative to other users. In yet another embodiment, virtual points may be awarded to an influential user. Such virtual points may be temporarily applied by the user to content thereby boosting a ranking of the content.

Such a score and/or a determination of a user's influence may be used to adjust an advertising cost and/or to channel content. In this regard, content may be channeled to highly influential users in order to increase the popularity/virality of content (e.g., via content owners/promoters). Further, users having influence on content may be identified as content curators such that other users are enabled to discover content via the content curators (e.g., via a channel that is dedicated to that user or by “following” such a user). Lastly, a user interface may be provided to the user that represents the viral influence of the user with respect to different content and with respect to other users (e.g., via a dashboard, chart, graph, etc.).

### Hardware Environment

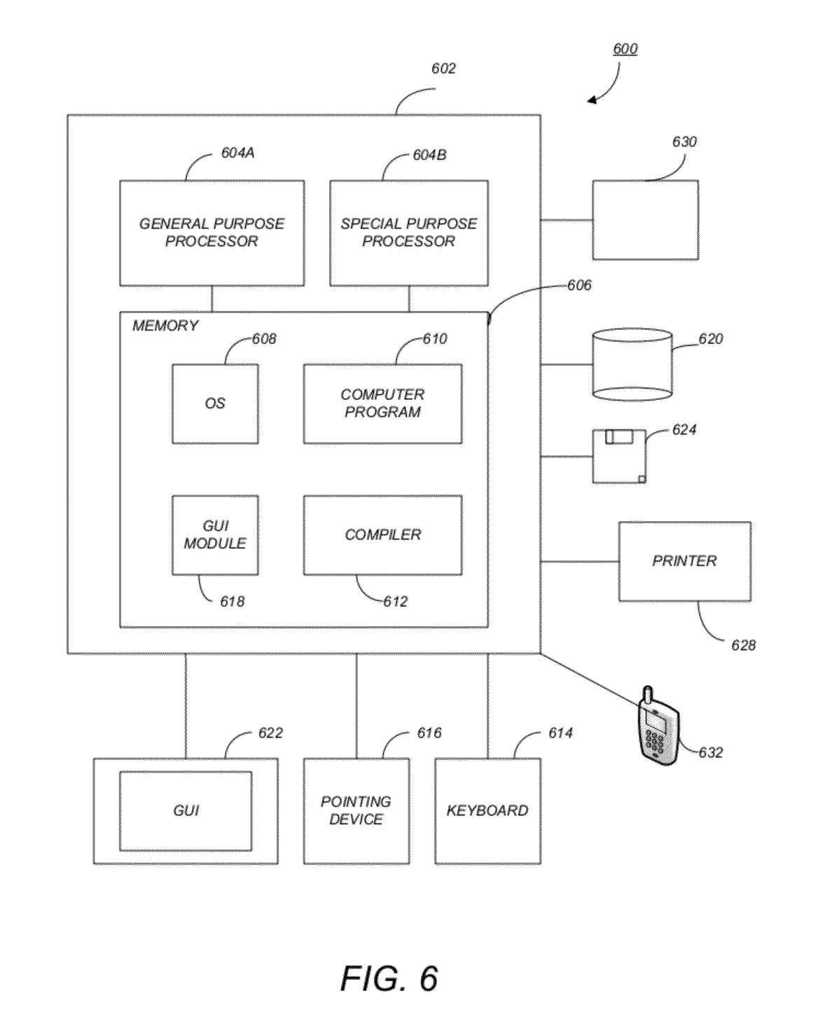

FIG. 6 is an exemplary hardware and software environment 600 used to implement one or more embodiments of the invention. The hardware and software environment includes a computer 602 and may include peripherals. Computer 602 may be a user/client computer, server computer, or may be a database computer. The computer 602 comprises a general purpose hardware processor 604A and/or a special purpose hardware processor 604B (hereinafter alternatively collectively referred to as processor 604) and a memory 606, such as random access memory (RAM). The computer 602 may be coupled to, and/or integrated with, other devices, including input/output (I/O) devices such as a keyboard 614, a cursor control device 616 (e.g., a mouse, a pointing device, pen and tablet, touch screen, multi-touch device, etc.) and a printer 628. In one or more embodiments, computer 602 may be coupled to, or may comprise, a portable or media viewing/listening device 632 (e.g., an MP3 player, iPod™, Nook™, portable digital video player, cellular device, personal digital assistant, etc.). In yet another embodiment, the computer 602 may comprise a multi-touch device, mobile phone, gaming system, internet enabled television, television set top box, or other internet enabled device executing on various platforms and operating systems.

In one embodiment, the computer 602 operates by the general purpose processor 604A performing instructions defined by the computer program 610 under control of an operating system 608. The computer program 610 and/or the operating system 608 may be stored in the memory 606 and may interface with the user and/or other devices to accept input and commands and, based on such input and commands and the instructions defined by the computer program 610 and operating system 608, to provide output and results.

Output/results may be presented on the display 622 or provided to another device for presentation or further processing or action. In one embodiment, the display 622 comprises a liquid crystal display (LCD) having a plurality of separately addressable liquid crystals. Alternatively, the display 622 may comprise a light emitting diode (LED) display having clusters of red, green and blue diodes driven together to form full-color pixels. Each liquid crystal or pixel of the display 622 changes to an opaque or translucent state to form a part of the image on the display in response to the data or information generated by the processor 604 from the application of the instructions of the computer program 610 and/or operating system 608 to the input and commands. The image may be provided through a graphical user interface (GUI) module 618. Although the GUI module 618 is depicted as a separate module, the instructions performing the GUI functions can be resident or distributed in the operating system 608, the computer program 610, or implemented with special purpose memory and processors.

In one or more embodiments, the display 622 is integrated with/into the computer 602 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 602 according to the computer program 610 instructions may be implemented in a special purpose processor 604B. In this embodiment, the some or all of the computer program 610 instructions may be implemented via firmware instructions stored in a read only memory (ROM), a programmable read only memory (PROM) or flash memory within the special purpose processor 604B or in memory 606. The special purpose processor 604B may also be hardwired through circuit design to perform some or all of the operations to implement the present invention. Further, the special purpose processor 604B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 602 may also implement a compiler 612 that allows an application program 610 written in a programming language such as COBOL, Pascal, C++, FORTRAN, or other language to be translated into processor 604 readable code. Alternatively, the compiler 612 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 610 accesses and manipulates data accepted from I/O devices and stored in the memory 606 of the computer 602 using the relationships and logic that were generated using the compiler 612.

The computer 602 also optionally comprises an external communication device such as a modem, satellite link, Ethernet card, or other device for accepting input from, and providing output to, other computers 602.

In one embodiment, instructions implementing the operating system 608, the computer program 610, and the compiler 612 are tangibly embodied in a non-transient computer-readable medium, e.g., data storage device 620, which could include one or more fixed or removable data storage devices, such as a zip drive, floppy disc drive 624, hard drive, CD-ROM drive, tape drive, etc. Further, the operating system 608 and the computer program 610 are comprised of computer program instructions which, when accessed, read and executed by the computer 602, cause the computer 602 to perform the steps necessary to implement and/or use the present invention or to load the program of instructions into a memory, thus creating a special purpose data structure causing the computer to operate as a specially programmed computer executing the method steps described herein. Computer program 610 and/or operating instructions may also be tangibly embodied in memory 606 and/or data communications devices 630, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 602.

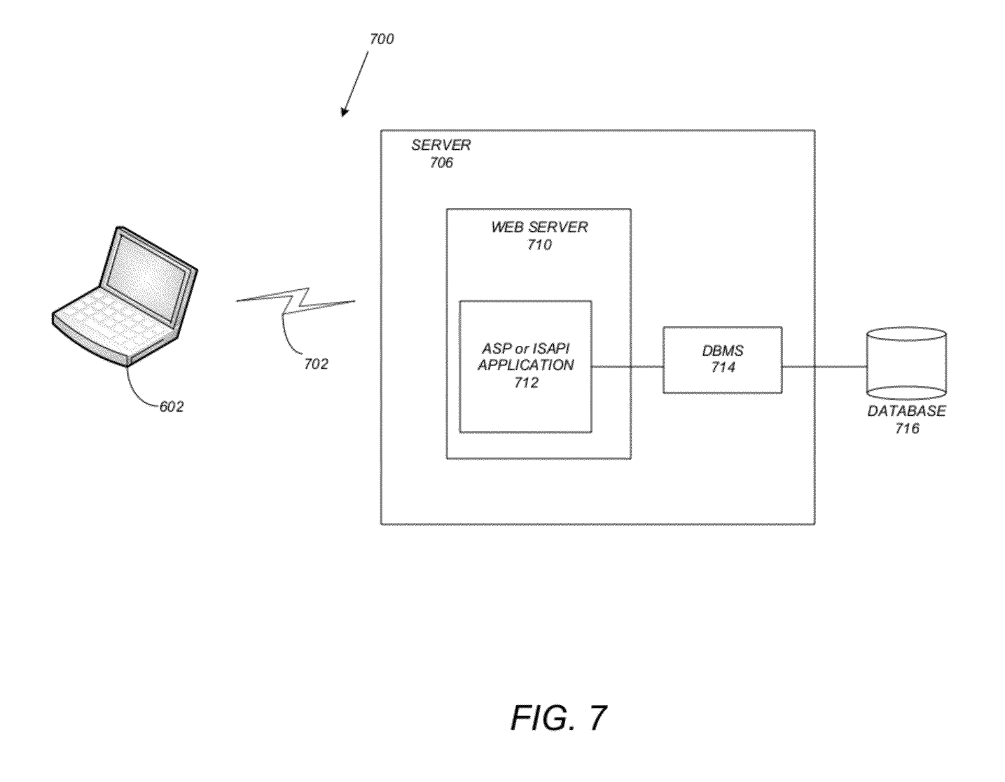

FIG. 7 schematically illustrates a typical distributed computer system 700 using a network 702 to connect client computers 602 to server computers 706. A typical combination of resources may include a network 702 comprising the Internet, LANs (local area networks), WANs (wide area networks), SNA (systems network architecture) networks, or the like, clients 602 that are personal computers or workstations, and servers 706 that are personal computers, workstations, minicomputers, or mainframes (as set forth in FIG. 6). However, it may be noted that different networks such as a cellular network (e.g., GSM [global system for mobile communications] or otherwise), a satellite based network, or any other type of network may be used to connect clients 602 and servers 706 in accordance with embodiments of the invention.

A network 702 such as the Internet connects clients 602 to server computers 706. Network 702 may utilize Ethernet, coaxial cable, wireless communications, radio frequency (RF), etc. to connect and provide the communication between clients 602 and servers 706. Clients 602 may execute a client application or web browser and communicate with server computers 706 executing web servers 710. Such a web browser is typically a program such as MICROSOFT INTERNET EXPLORER™, MOZILLA FIREFOX™, OPERA™, APPLE SAFARI™, etc. Further, the software executing on clients 602 may be downloaded from server computer 706 to client computers 602 and installed as a plug-in or ACTIVEX™ control of a web browser. Accordingly, clients 602 may utilize ACTIVEX™ components/component object model (COM) or distributed COM (DCOM) components to provide a user interface on a display of client 602. The web server 710 is typically a program such as

### Microsoft's Internet Information Server™.

Web server 710 may host an Active Server Page (ASP) or Internet Server Application Programming Interface (ISAPI) application 712, which may be executing scripts. The scripts invoke objects that execute business logic (referred to as business objects). The business objects then manipulate data in database 716 through a database management system (DBMS) 714. Alternatively, database 716 may be part of, or connected directly to, client 602 instead of communicating/obtaining the information from database 716 across network 702. When a developer encapsulates the business functionality into objects, the system may be referred to as a component object model (COM) system. Accordingly, the scripts executing on web server 710 (and/or application 712) invoke COM objects that implement the business logic. Further, server 706 may utilize MICROSOFT'S™ Transaction Server (MTS) to access required data stored in database 716 via an interface such as ADO (Active Data Objects), OLE DB (Object Linking and Embedding DataBase), or ODBC (Open DataBase Connectivity).

Generally, these components 700-716 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 602 and 706 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 602 and 706.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for tracking user interaction with content, comprising:
recognizing an interaction with content by a user;
communicating data related to said interaction, in a first engagement message, to a publishing service application, wherein the data comprises a user identity for the user, a content identity for the content interacted with, an engagement type and a previous user identity of the previous user who directly influenced the interaction;
determining at said publishing service a likelihood that the interaction will cause other users to further interact with the content; and
upon a positive determination that the interaction will cause other users to further interact with the content, communicating said determination to a viral influence application.

2. A method in accordance with claim 1, wherein said viral influence application tracks a history of the interaction with the content by tracking:
the user identity;
the content identity; and
the previous user identity, for a previous user that interacted with the content.

3. A method in accordance with claim 1, wherein said viral influence application:
generates a list of the previous users that previously interacted with the content, wherein the list comprises an indication as to how far away a current interaction is relative to interactions of said previous users.

4. A method in accordance with claim 3, wherein:
said list is utilized by said publishing service application to generate a new engagement message for each of the previous users;
the new engagement message comprises:
the user identity and the content identity from the first engagement message;
the previous user identity;
a first indication regarding how far away a current interaction is relative to said previous user; and
a viral engagement indication that indicates that the user did not directly perform the interaction but that that interaction was performed indirectly as a result of the user's interaction.

5. A method in accordance with claim 4, wherein an engagement aggregator service application uses said new engagement message generated by said publishing service application to aggregate the data provided by said new engagement message.

6. A method in accordance with claim 5, wherein said data is aggregated:
at a first granularity level that comprises the content identity and the engagement type; and
at a second granularity level that comprises the user identity, the content identity and the engagement type.

7. A method in accordance with claim 5, wherein said aggregated data is stored by said engagement aggregator service application for a predetermined period of time before forwarding said aggregated data to a storage service application for storage.

8. A method in accordance with claim 1, further comprising:
a storage service application that is configured to:
store the data related to the interaction at two or more levels of granularity; and
track a date/time that the data related to each interaction is stored by said storage service application.

9. A method in accordance with claim 8, wherein said storage service application is further configured to aggregate the data related to the interaction by time once the data has been stored for a predetermined time period.

10. A method in accordance with claim 1, wherein said interaction comprises a sharing of the content, a viewing of the content, or an indication that the user likes the content.

11. A method in accordance with claim 1, wherein said interaction comprises sharing the content to a secondary site followed by linking the content back to a primary site or by receiving a communication at said primary site that such sharing has occurred.

12. A method in accordance with claim 1, wherein the viral influence application is configured to determine users having influence on the content relative to other users.

13. A method in accordance with claim 12, wherein for a specified user and engagement type, said viral influence application sums all interactions for the content wherein the user directly performed the interaction, wherein the sum represents a total influence that the user had on the content; and further comparing said sum to a corresponding sum of at least another user to determine the relative influence the user had on the content.

14. A method in accordance with claim 13, further comprising:
for a specified user, having different engagement types with the same content, computing a composite score based upon relative weighting of said different engagement types.

15. A method in accordance with claim 13, wherein said viral influence application sums scores for all engagement types, for a plurality of users, on all content on a site, to determine the user, from the plurality of users, having a larger overall influence on said site relative to at least another user.

16. A method in accordance with claim 15, further comprising awarding a level or experience points to the user in a reputation or other game based upon the user's summed score for all engagement types on all content.

17. A method in accordance with claim 12, wherein information relating to users having influence on content relative to other users is utilized to adjust an advertising cost.

18. A method in accordance with claim 12, wherein content is channeled to users having influence on content relative to other users.

19. A method in accordance with claim 12, wherein users having influence on content relative to other users are identified as content curators, wherein other users are enabled to discover content via the content curators.

20. A method in accordance with claim 12, wherein users having relatively larger viral influence are given awards or other recognition.

21. A method in accordance with claim 12, wherein users having influence on content relative to other users are awarded communications access or priority to a network host, affiliate or content owner.

22. A method in accordance with claim 12, further comprising awarding users having influence on content relative to other users with virtual points in a network, wherein:
virtual points may be temporarily applied by said users to the content, thereby boosting a ranking of the content.

23. A method in accordance with claim 1, further comprising providing a user interface to the user representing a viral influence of the user with respect to the content and with respect to other users.

24. A system for tracking user interaction with content, the system comprising:
(a) a computer having a memory; and
(b) an application executing on the computer, wherein the application is configured to:
(i) recognize an interaction with content by a user;
(ii) communicate data related to said interaction, in a first engagement message, to a publishing service application, wherein the data comprises a user identity for the user, a content identity for the content interacted with, an engagement type and a previous user identity for the previous user who directly influenced the interaction;
(iii) determine at said publishing service a likelihood that the interaction will cause other users to further interact with the content; and
(iv) upon a positive determination that the interaction will cause other users to further interact with the content, communicating said determination to a viral influence application.
